(19) United States
(12) Patent Application Publication
(10) Pub. No.: US 2009/0150967 A1
(43) Pub. Date: Jun. 11, 2009

(54) METHOD AND DEVICE FOR RECEIVING WIRELESS BROADCAST SIGNALS

(75) Inventors: Chung-Jen Chen, Taipei (TW); Hung-Shen Su, Taipei (TW)

Correspondence Address: KIRTON AND MCCONKIE, 60 EAST SOUTH TEMPLE,, SUITE 1800, SALT LAKE CITY, UT, 84111, US

(73) Assignee: AVERMEDIA TECHNOLOGIES, INC., Taipei (TW)

(21) Appl. No.: 12/167,770

(22) Filed: Jul. 3, 2008

(30) Foreign Application Priority Data
Dec. 6, 2007 (TW) 096146599

(51) Int. Cl. H04N 7/16

(52) U.S. Cl. 725/153

(57) ABSTRACT

A method and a device for receiving wireless broadcast signals are provided. The device includes a positioning module, a memory storing therein a first information table and a second information table, a signal-receiving and processing module, a processor and a client terminal. The method includes steps of: receiving a first wireless broadcast signal at a first frequency contained in the first information table and presenting contents represented by the first wireless broadcast signal when the device is positioned in a first broadcast area; automatically searching for a second frequency in the second information table when the device is positioned in a second broadcast area wherein the second frequency corresponds to the information associated with the first frequency in the first information table; and receiving a second wireless broadcast signal at the second frequency and presenting contents represented by the second wireless broadcast signal.

### FIELD OF THE INVENTION

The present invention relates to a method and a device for receiving wireless broadcast signals, and more particularly to a method and a device for receiving wireless broadcast signals during transportation between different broadcast areas.

### BACKGROUND OF THE INVENTION

Recent TV programs include cable TV programs and wireless TV programs. The wireless broadcasting is the over-the-air distribution of video signals which transmit programs to an audience by radio frequency signals. The wireless signals are received and then displayed by television or receiver for wireless broadcast signals or TV signals. Thus, the audience can watch TV programs represented by the wireless signals.

The technology related to wireless TV programs has been highly developed and the wireless TV signals can transmit data for relatively wider area. In the effective broadcast area of a broadcast station, a simple antenna device or other receiver device for the wireless TV signals can receive and convert the wireless signals into video data to be displayed to the audience. If the receiver device is implemented by a mobile way, the user can receive TV signals and watch TV programs conveniently in mobile environments.

With increasing development of mobile computing technology industries, a variety of portable electronic devices such as notebook computers, mobile phones, personal digital assistants (PDAs) or small-size liquid crystal display (LCD) continues to make progress. Wireless TV programs can be shown through these portable electronic devices in mobile environments. For example, the user can watch TV programs through a notebook computer by installing a built-in or external TV tuner card to receive wireless TV signals by an antenna device of the TV tuner card. In other conditions, personal digital assistants or mobile phones such as third generation (3G) mobile phones receive wireless TV signals via wireless network service provided by individual telecommunication company.

A broadcast station generally issues wireless TV signals at specific frequency which should be received at the specific frequency in specific area. For a specific TV channel, it is possible that different broadcast stations issue the corresponding wireless TV signals at different frequencies. When the audience crosses the boundary between two areas respectively covered by two broadcast stations, the receiver device may fail to receive the wireless TV signals since the frequency for the same TV channel varies in the first broadcast area and the second broadcast area.

FIG. 1 is a schematic diagram illustrating a vehicle crossing a boundary between two broadcast areas. A mobile wireless receiver device (not shown) for receiving wireless TV signals is carried by the vehicle 10 and shows a wireless TV program of a channel. In the first area a1, the broadcast station 11 broadcasts the TV program by wireless signals at frequency of 512 MHz. In the second area a2, the broadcast station 12 broadcasts the same TV program by wireless signals at frequency of 587 MHz.

In practice, the mobile receiver device can receive the wireless TV signals at frequency at both 521 MHz and 587 MHz in the overlap between the two broadcast areas a1 and a2. In the non-overlapping area, however, only one frequency of 521 MHz and 587 MHz is acceptable to receive the wireless TV signals. Thus, when the vehicle leaves the first broadcast area a1 and enters the broadcast area a2, the wireless TV program that the user is watching cannot be properly displayed.

Another similar experience of listening to broadcast program on the radio is taken as an example. For power or authority consideration, radio signals are issued at different frequencies in different areas. The listener should adjust the receiving frequency to listen to a specific channel on the radio when he drives on freeway to pass several areas. Further, it is inconvenient since the listener has to know the receiving frequency of the specific channel in the areas in advance.

Different countries or regions have different broadcasting standards of wireless digital television. Hence, moving through different countries or regions will encounter the same problem in receiving wireless digital TV signals. For example, there are many countries and regions in the European continent and American. The user of the mobile receiver device is likely to pass through different countries and regions in the continent. Such problem occurs frequently if some countries or regions have smaller territory areas. Referring back to FIG. 1, the first broadcast area a1 and the second broadcast area a2 may represent two adjacent countries or two adjacent regions with different broadcasting standards. When a specific channel is broadcast in both areas, the receiving frequencies are usually different in these areas.

A method has been proposed to solve this problem by full-frequency scan. The wireless receiver device auto-scans the channels in the second area a2 and updates the information. The user browses the updated information and selects the desired channel. Since the scanning and updating steps take much time, it is inconvenient that the scanning and updating steps should be done as long as the user crosses the boundary between two broadcast areas.

### SUMMARY OF THE INVENTION

The present invention provides a method and a device for receiving wireless broadcast signals. The device can automatically adjust receiving frequency to properly receive the wireless broadcast signals when the device passes through different broadcast areas.

In accordance with an aspect of the present invention, a method for receiving wireless broadcast signals is applied to a device storing therein a first information table and a second information table. The method includes steps of: receiving a first wireless broadcast signal at a first frequency contained in the first information table and presenting contents represented by the first wireless broadcast signal when the device is positioned in a first broadcast area; automatically searching for a second frequency in the second information table when the device is positioned in a second broadcast area wherein the second frequency corresponds to the information associated with the first frequency in the first information table; and receiving a second wireless broadcast signal at the second frequency and presenting contents represented by the second wireless broadcast signal.

In accordance with another aspect of the present invention, a device receiving a first wireless broadcast signal in a first broadcast area and a second wireless broadcast signal in a second broadcast area is provided. The device includes a positioning module for providing a current position information; a memory storing a first information table and a second information table wherein the first information table includes at least a first frequency and the second information table includes at least a second frequency; a signal-receiving and processing module for receiving and processing the first wireless broadcast signal and the second wireless broadcast signal; a processor controlling the signal-receiving and processing module to receive the first wireless broadcast signal at the first frequency when the device is positioned in the first broadcast area and receive the second wireless broadcast signal at the second frequency when the device is positioned in the second broadcast area according to the current position information, and then processing and outputting the wireless broadcast signal; and a client terminal for presenting the signal outputted from the processor. The processor searches for the second frequency in the second information table according to the channel information corresponding to the first frequency in the first information table.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic diagram illustrating two broadcast stations issuing wireless TV signals in two broadcast areas;

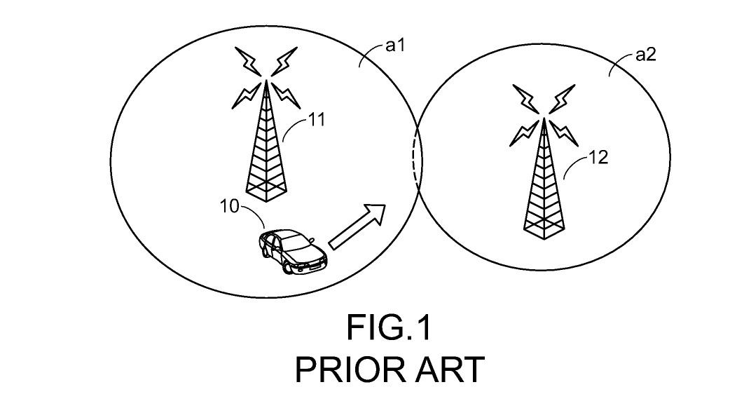

FIGS. 2A and 2B are schematic diagrams showing the use of a device for receiving wireless broadcast signals according to a preferred embodiment of the present invention;

FIG. 3 is a schematic functional block diagram illustrating the device for receiving wireless broadcast signals according to the present invention;

FIG. 4 is a flowchart illustrating a method for receiving wireless broadcast signals applied to the device of FIGS. 2A and 2B;

FIGS. 5A and 5B are schematic diagrams showing the use of a device for receiving wireless broadcast signals according to another preferred embodiment of the present invention; and

FIG. 6 is a flowchart illustrating a method for receiving wireless broadcast signals applied to the device of FIGS. 5A and 5B.

### DETAILED DESCRIPTION OF THE PREFERRED EMBODIMENT

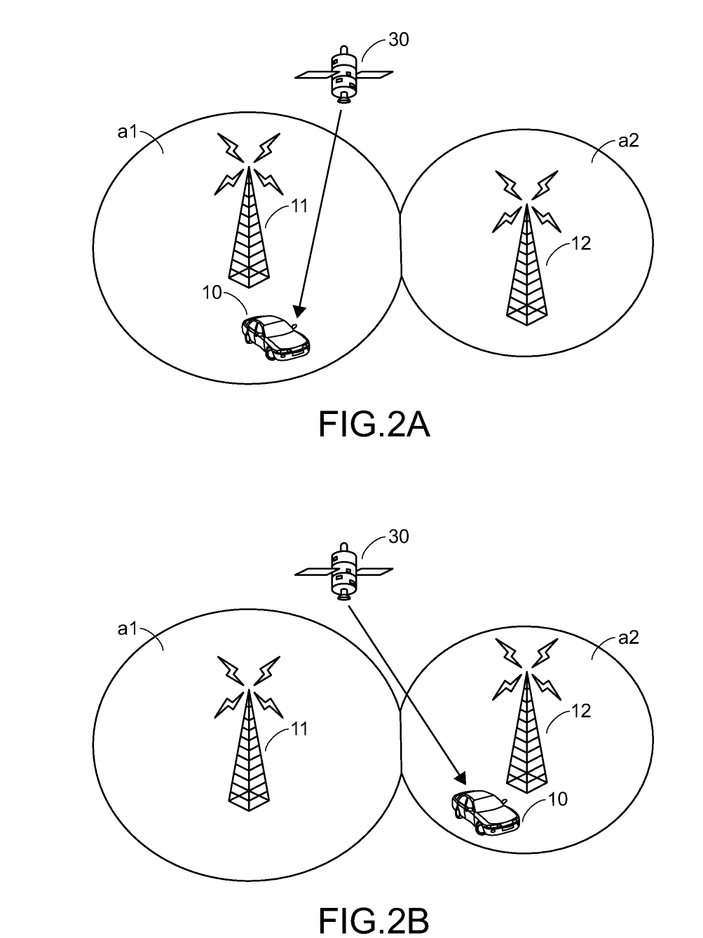

FIGS. 2A and 2B are schematic diagrams showing the use of a device for receiving wireless broadcast signals according to a preferred embodiment of the present invention. A TV program of a specific channel is broadcast by the first broadcast station 11 in the first broadcast area a1 and the second broadcast station 12 in the second broadcast area a2. The receiving frequencies of the wireless broadcast signals are different in these two broadcast areas a1 and a2. A device of the present invention is carried by a vehicle 10 while there is a TV program presented by the device. The user cannot watch the TV program when the vehicle 10 leaves the first broadcast area a1 and enters the second broadcast area a2 due to incorrect receiving frequency.

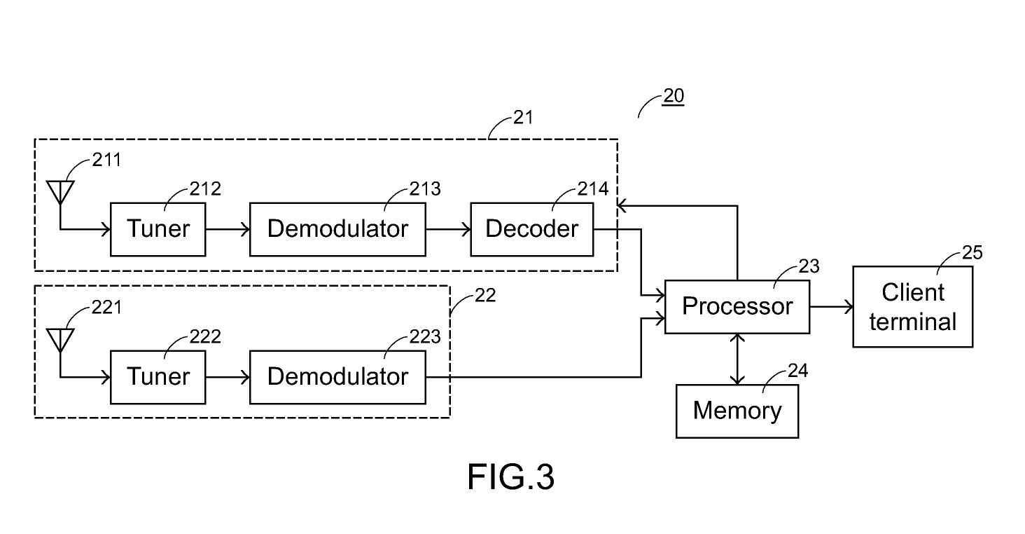

A positioning technology is used to detect the current position of the device. The device automatically adjusts the receiving frequency to receive the wireless broadcast signals according to the current position. Please refer to FIG. 3, a schematic functional block diagram illustrating the device 20 for receiving wireless broadcast signals according to the present invention. The device 20 is installed or disposed in the vehicle 10. In an embodiment, the device 20 involves a mobile digital television or a notebook computer with a built-in or external TV turner card.

The device 20 for receiving wireless broadcast signals includes a signal-receiving and processing module 21 for receiving and processing the wireless broadcast signals, e.g. digital TV signals or digital radio signals, so that the device 20 can present wireless TV program or radio program. The device 20 further includes a positioning module 22 for receiving a positioning signal issued by a satellite positioning system such as global positioning system (GPS). For example, the current position is obtained from a satellite positioning signal issued from the satellite 20 in FIGS. 2A and 2B.

As shown in FIG. 3, the signal-receiving and processing module 21 includes an antenna 211 for receiving the wireless broadcast signals and a tuner 212 for tuning the received signals. If the wireless signals are digital signals, a demodulator 213 is provided for demodulating the signals. Then, a decoder 214 decodes the signals and performs format conversion. The positioning module 22 includes an antenna 221 for receiving the satellite positioning signal from the satellite 30, and a tuner 222 for tuning the received satellite positioning signal. If the positioning signal is an analog signal, an analog-to-digital converter (not shown) is provided for format conversion. Then, a demodulator 223 demodulates the signal. The signal-receiving and processing module 21 is a basic module of a digital TV tuner card or a digital television, and the positioning module 22 is a basic module of a client-end device of a satellite positioning system. Hence, the details of these modules 21 and 22 aren't explained hereinafter.

The device 20 for receiving the wireless broadcast signals further includes a processor 23 designed for processing the wireless broadcast signals and the satellite positioning signal. The satellite positioning signal is processed to provide the information of the current position of the device 20. Hence, the device 20 gets the information including the longitude and latitude of the vehicle 10 and in which broadcast area the vehicle 10 is positioned. Furthermore, after the processor 23 processes the wireless broadcast signals, the data such of video data or audio data transmitted by the wireless broadcast signals are outputted to a client terminal 25. For example, video data are shown on a monitor and audio data are played by a radio.

The memory 24 stores many information and parameters associated with every broadcast area. The memory 24 is implemented by a hard disc or a flash memory which can keep stored data without power. Please refer back to FIGS. 2A and 2B. For a specific channel, the first broadcast station 11 in the first broadcast area a1 and the second broad cast station 12 in the second broadcast area a2 transmit wireless broadcast signals at different frequencies. Thus, a first information table (TABLE 1) associated with the first broadcast area a1 and a second information table (TABLE 2) associated with the second broadcast area a2 are stored in the memory 24.

TABLE 1

| | |
|---|---|
| HBO | 473 MHz |
| CNN | 485 MHz |
| FIBA | 521 MHz |
| ABC | 563 MHz |
| ABCsport | 611 MHz |

TABLE 2

| | |
|---|---|
| ESPN | 479 MHz |
| CNN | 485 MHz |
| FIBA | 587 MHz |

TABLE 1 shows the channels and corresponding receiving frequencies in the first broadcast area a1, and TABLE 2 shows the channels and corresponding receiving frequencies in the second broadcast area a2. The channels may be TV channels or radio channels. The information table may contain channel frequency, channel identifier, channel name and the like. In digital television application, the information may include channel information or program information in a streaming data. The information that the information table may contain isn't entirely listed herein. In this embodiment, only part information is listed in the information table for concise purpose. The first information table (TABLE 1) contains five channels and associated information, while the second information table (TABLE 2) contains three channels and associated information.

In this embodiment, in the first broadcast area a1, channel FIBA has first wireless broadcast signals at a first frequency of 521 MHz, but has second wireless broadcast signals at a second frequency of 587 MHz in the second broadcast area a2. The first wireless broadcast signals and the second wireless broadcast signals represent the same broadcast content. When the vehicle 10 leaves the first broadcast area a1 and enters the second broadcast a2, the receiving frequency should be changed from 521 MHz into 587 MHz for properly receive the wireless broadcast signals.

Please be noted that the information in the information tables are collected and arranged in advance. The information tables are loaded into the memory 24 so that the device can automatically adjust the receiving frequency according to the current position obtained from the positioning module.

Furthermore, in some broadcast areas (regions or countries) the information, e.g. channel titles, channel identifiers, or channel receiving frequencies, may be adjusted or changed occasionally. The user may update the information tables to get the latest information. One approach is to load the information tables into the memory 24 by executing an application program through network or storage media such as optical disc or floppy disk containing the latest information provided by the producer or supplier of the device 20.

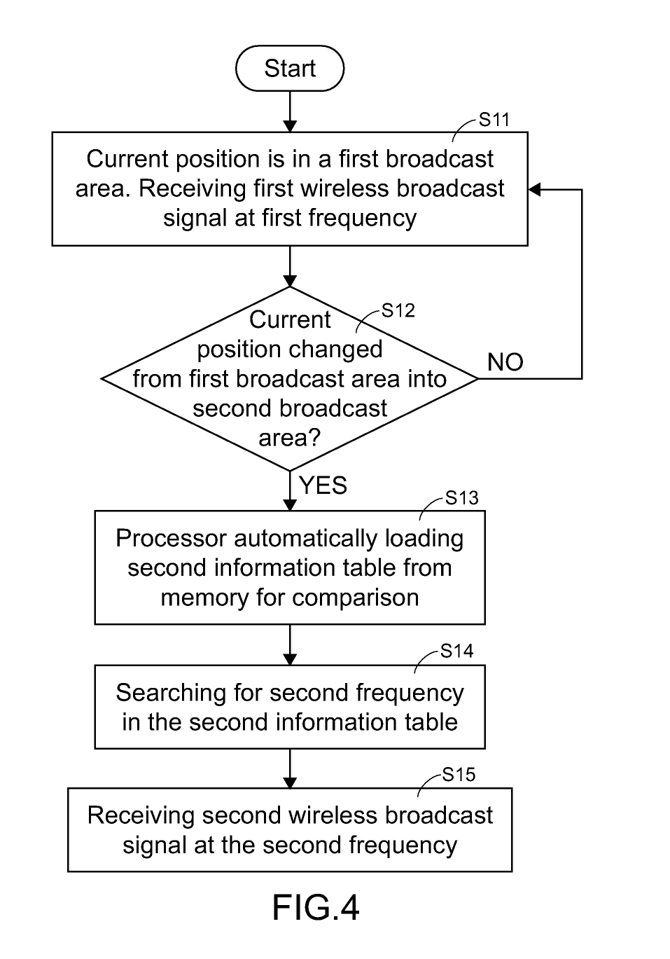

Please refer FIG. 4, a flowchart illustrating a method for receiving wireless broadcast signals according to a first embodiment of the present invention. The vehicle 10 is moving from the first broadcast area a1 toward the second broadcast area a2. At step S11, the device 20 detects that the vehicle 10 is located in the first broadcast area a1 according to the current position information. Hence, the device 20 receives the wireless broadcast signals based on the first information table (TABLE 1). In this embodiment, the device receives the wireless broadcast signals of channel FIBA issued from the first broadcast station 11 at the first frequency of 521 MHz. When the device 20 detects that the current position changes and the vehicle 10 enters the second broadcast area a2 at step S12, the processor 23 automatically loads the second information table (TABLE 2) from the memory 24 for comparison with the first information table (TABLE 1) at step S13.

At step 14, the processor 23 finds out the channel title, i.e. channel FIBA, or channel identifier corresponding to the first receiving frequency (512 MHz) according to the first information table (TABLE 1). Then, the processor 23 searches the second information table (TABLE 2) to find out the second receiving frequency (587 MHz) corresponding the same channel title, i.e. channel FIBA, or channel identifier. Since the channel title or channel identifier is unique, it is impossible that any two channels have the same channel title and channel identifier. If the information tables are collected thoroughly, the processor 23 can accurately search the corresponding receiving frequency according to the current position.

At step 15, after the second receiving frequency (587 MHz) is determined, the signal-receiving and processing module 21 receives the second wireless broadcast signals of the same channel FIBA issued from the second broadcast station 12 at the second receiving frequency in the second broadcast area a2. Since the first wireless broadcast signals and the second wireless broadcast signals represent the same contents in channel FIBA, this transformation doesn't affect the play of the TV/radio program. The receiving frequency is automatically changed from the first frequency (521 MHz) into the second frequency (587 MHz) without manual operation.

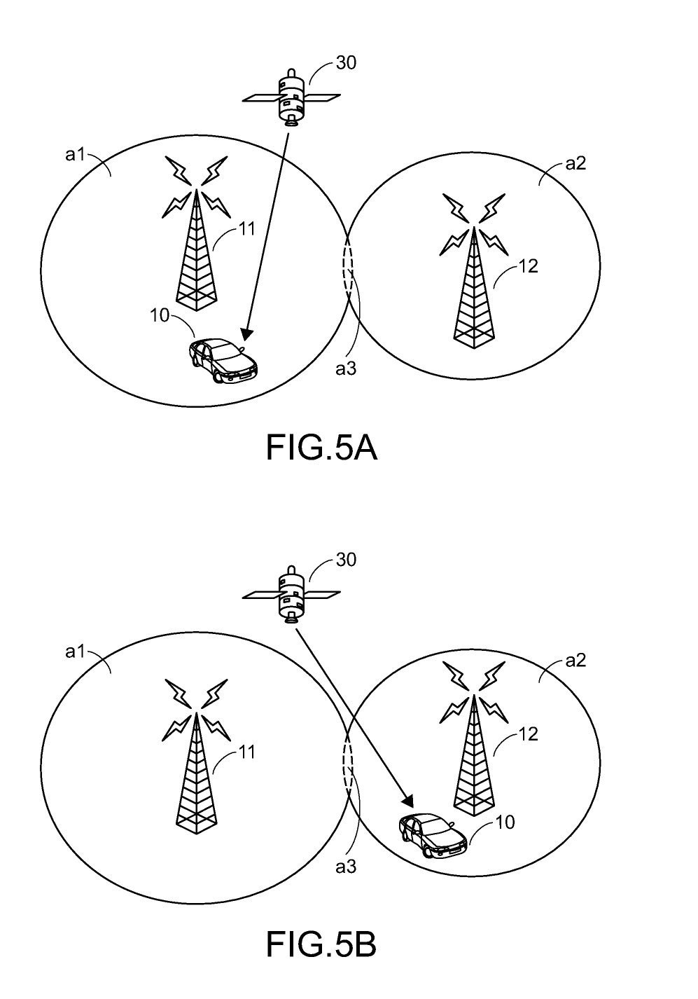

In the first embodiment, the two broadcast areas doesn't overlap. FIGS. 5A and 5B show that there is an overlapping area a3 between the two broadcast areas a1 and a2. When the vehicle 10 is positioned in the overlapping area a3, the first receiving frequency and the second receiving frequency are allowed to be used to receive the wireless broadcast signals.

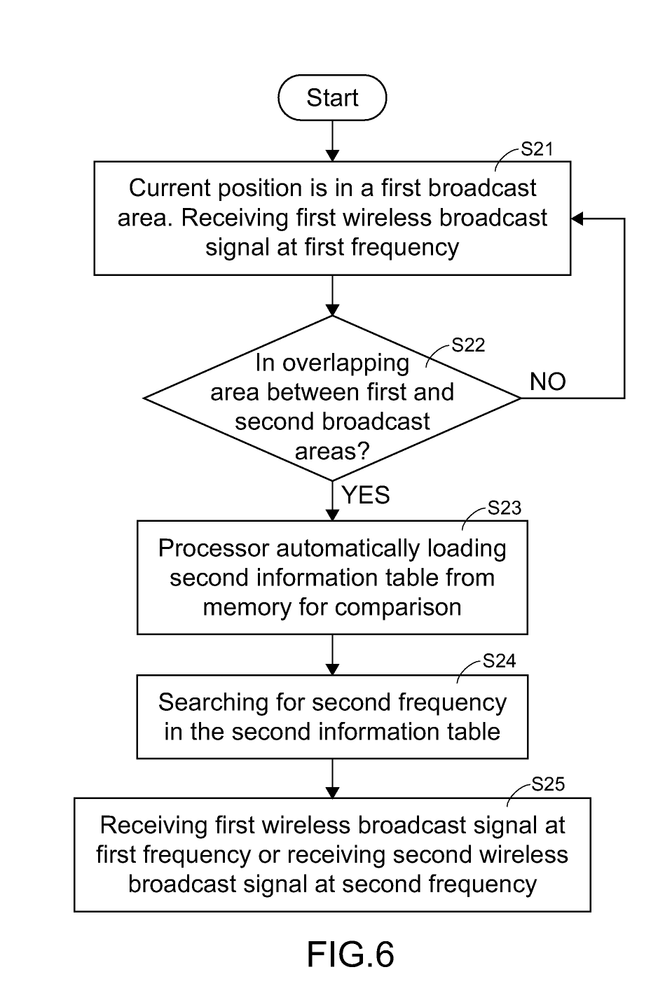

Please refer to FIG. 6, a flowchart illustrating a method for receiving wireless broadcast signals according to a second embodiment of the present invention. The vehicle 10 is moving from the first broadcast area a1 toward the second broadcast area a2. At step S21, the device 20 detects that the vehicle 10 is located in the first broadcast area a1 according to the current position information. Hence, the device 20 receives the wireless broadcast signals based on the first information table (TABLE 1). In this embodiment, the device receives the wireless broadcast signals of channel FIBA issued from the first broadcast station 11 at the first frequency of 521 MHz.

When the device 20 detects that the current position changes and the vehicle 10 is positioned in the overlapping area a3 at step S22, the processor 23 automatically loads the second information table (TABLE 2) from the memory 24 for comparison with the first information table (TABLE 1) at step S23. Before the second receiving frequency is checked as the correct frequency, the processor doesn't remove the first information table (TABLE 1).

A broadcast area of a broadcast station is always clearly defined. For example, the broadcast area may be defined by the location of the broadcast station with a broadcast radius or defined by longitude and latitude data. Hence, the processor 23 can determine whether the vehicle is in the overlapping area a3 between the two broadcast areas a1 and a2 or not according to the current position information obtained from the satellite positioning system.

Furthermore, the designer may define the overlapping area a3 between the two broadcast areas beforehand and loads the related information into the memory by executing an application program. The designer or user can adjust the definition of the overlapping area a3 to make sure that a second receiving frequency has been found out before the first wireless broadcast signals aren't properly received anymore.

In particular, when the vehicle 10 is positioned in the overlapping area a3 between the two broadcast areas a1 and a2, the device 20 alternately receives the first wireless broadcast signals and the second wireless broadcast signals to find out the signals with the better quality. The second receiving frequency is obtained at step S24 which is similar to the step S14 of the first embodiment. When the current position is positioned in the overlapping area a3, the processor 23 may prefer receiving the first wireless broadcast signals at the first frequency of 521 MHz or alternately receive the first wireless broadcast signals at the frequency of 521 MHz and the second wireless broadcast signals at the frequency of 587 MHz, both belongs to the same channel, i.e. channel FIBA (step S25). Since the first and second wireless broadcast signals represent the same content in channel FIBA, the device 20 can select ones of the first and second wireless broadcast signals.

The power of the wireless broadcast signals decreases with the distance to the broadcast station. If the current position information indicates that the vehicle 10 moves toward the second broadcast area a2, the power of the first wireless broadcast signals gradually decreases and that of the second wireless broadcast signals gradually increases. Hence, the device 20 can be designed to receive the second wireless broadcast signals in the overlapping area a3.

According to the above-described concept, the second receiving frequency is obtained and selected by auto search and auto selection without manual operation. It is unnecessary for the user to know where the vehicle 10 is. The device 20 can receive specific signals at a proper frequency and doesn't affect the play of the program.

After the vehicle 10 entirely leaves the first broadcast area a1 and enters the second broadcast area a2, the device 20 receives the wireless broadcast signals according to the information in the second information table (TABLE 2) instead of the first information table (TABLE 1). On the contrary, if the vehicle 10 moves from the second broadcast area a2 toward the first broadcast a1, we just have to exchange the “first” and “second” words in the description to reverse the condition. The applicable conditions further include that the vehicle 10 enters a third broadcast area (not shown) or the overlapping area are located among more than two broadcast areas.

Hence, when an audience or a listener travels many countries or regions over the European continent or American, he can watch digital TV programs or listen to digital radio programs in the vehicle even though the receiving frequencies of the wireless broadcast signals varies in different broadcast areas. The present invention provides an automatic receiving method without manual operation to solve the problems encountered in the prior arts. The present invention is also applied to satellite TV programs because the frequencies of different satellites may vary. The device of the present invention can be utilized, provided that the signal-receiving and processing module is capable of receiving the satellite TV signals, to receive satellite TV programs broadcast by different satellite systems.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for receiving wireless broadcast signals applied to a device storing therein a first information table and a second information table, wherein the method comprises steps of:
receiving a first wireless broadcast signal at a first frequency contained in the first information table and presenting contents represented by the first wireless broadcast signal when the device is positioned in a first broadcast area;
automatically searching for a second frequency in the second information table when the device is positioned in a second broadcast area wherein the second frequency corresponds to the information associated with the first frequency in the first information table; and
receiving a second wireless broadcast signal at the second frequency and presenting contents represented by the second wireless broadcast signal.

2. The method according to claim 1, further comprises step of:
obtaining a current position information of the device by a positioning module of the device; and
determining whether the device is positioned in the first broadcast area or the second broadcast area according to the current position information.

3. The method according to claim 2 wherein the positioning module obtains the current position information by receiving a positioning signal issued from a satellite positioning system.

4. The method according to claim 1 wherein there is an overlapping area between the first broadcast area and the second broadcast area, and the method further comprises steps of:
automatically searching for a second frequency in the second information table when the device is positioned in the overlapping area wherein the second frequency corresponds to the information associated with the first frequency in the first information table; and
receiving the first wireless broadcast signal at the first frequency and presenting contents represented by the first wireless broadcast signal, or receiving the second wireless broadcast signal at the second frequency and presenting contents represented by the second wireless broadcast signal.

5. The method according to claim 4 wherein the overlapping area is defined by an application program loaded into the device.

6. The method according to claim 1 wherein the first information table and the second information table includes channel frequencies, channel identifiers and channel titles corresponding to the first wireless broadcast signal and the second wireless broadcast signal.

7. The method according to claim 6 wherein the searching step comprises steps of:
searching for the channel identifier and/or channel title corresponding to the first frequency in the first information table;
searching for the same channel identifier and/or channel title in the second information table; and
finding out the second frequency corresponding to the same channel identifier and/or channel title in the second information table.

8. The method according to claim 6 wherein the first wireless broadcast signal and the second wireless broadcast signal represent the same program content of the same channel.

9. The method according to claim 1 wherein the first wireless broadcast signal is transmitted at the first frequency in the first broadcast area and the second wireless broadcast signal is transmitted at the second frequency in the second broadcast area.

10. A device for receiving a first wireless broadcast signal in a first broadcast area and a second wireless broadcast signal in a second broadcast area, comprising:
a positioning module for providing a current position information;
a memory storing a first information table and a second information table wherein the first information table includes at least a first frequency and the second information table includes at least a second frequency;
a signal-receiving and processing module for receiving and processing the first wireless broadcast signal and the second wireless broadcast signal;
a processor controlling the signal-receiving and processing module to receive the first wireless broadcast signal at the first frequency when the device is positioned in the first broadcast area and receive the second wireless broadcast signal at the second frequency when the device is positioned in the second broadcast area according to the current position information, and then processing and outputting the wireless broadcast signal; and
a client terminal for presenting the wireless broadcast signal outputted from the processor,
wherein the processor searches for the second frequency in the second information table according to the channel information corresponding to the first frequency in the first information table.

11. The device according to claim 10 wherein the positioning module obtains the current position information by receiving a positioning signal issued from is satellite positioning system.

12. The device according to claim 10 wherein there is an overlapping area between the first broadcast area and the second broadcast area, and the processor controls the signal-receiving and processing module to selectively receive the first wireless broadcast signal at the first frequency and receive the second wireless broadcast signal at the second frequency when the device is positioned in the overlapping area.

13. The device according to claim 10 wherein the overlapping area is defined by an application program loaded into the device.

14. The device according to claim 10 wherein the first information table and the second information table includes channel frequencies, channel identifiers and channel titles corresponding to the first wireless broadcast signal and the second wireless broadcast signal.

15. The device according to claim 14 wherein the processor searches for the channel identifier and/or channel title corresponding to the first frequency in the first information table, and finds out the second frequency corresponding to the channel identifier and/or channel title in the second information table.

16. The device according to claim 14 wherein the first wireless broadcast signal and the second wireless broadcast signal represent the same program content of the same channel.

17. The device according to claim 10, characterized in that the first information table and the second information table stored in the memory are updatable.

18. The device according to claim 10 wherein the first wireless broadcast signal and the second wireless broadcast signal are video signals or audio signals.

19. The device according to claim 10 wherein the first wireless broadcast signal and the second wireless broadcast signal represent digital TV programs or digital radio programs.

20. The device according to claim 10 wherein the device is arranged in a vehicle so as to be moved from the first broadcast area to the second broadcast area.
